(19) United States
(12) Patent Application Publication
(10) Pub. No.: US 2011/0032390 A1
(43) Pub. Date: Feb. 10, 2011

(54) DIGITAL PHOTOGRAPHING APPARATUS AND MOVING PICTURE CAPTURING METHOD PERFORMED BY THE SAME

(75) Inventors: Chang-bae Lee, Gwacheon-si (KR); Seung-yong Kim, Goyang-si (KR)

Correspondence Address: DRINKER BIDDLE & REATH LLP;ATTN: PATENT DOCKET DEPT., 191 N. WACKER DRIVE, SUITE 3700, CHICAGO, IL, 60606, US

(73) Assignee: Samsung Electronics Co., Ltd., Suwon-si (KR)

(21) Appl. No.: 12/850,780

(22) Filed: Aug. 5, 2010

(30) Foreign Application Priority Data
Aug. 5, 2009 (KR) 10-2009-0072122

(51) Int. Cl. H04N 5/262; H04N 5/217

(52) U.S. Cl. 348/240.99; 348/241; 348/E05.055; 348/E05.078

(57) ABSTRACT

A digital photographing apparatus and a moving picture capturing method performed by the same, and more particularly to, a removal of noise of a digital photographing apparatus from sound of a moving picture when the moving picture is being captured. The method of photographing a moving picture performed by a digital photographing apparatus, the method including: executing a moving picture shooting mode; generating an operation control signal; operating the digital photographing apparatus according to the operation control signal; extracting an offset sound corresponding to the operation control signal; and combining a noise generated by the operation of the digital photographing apparatus and the offset sound.

### CROSS-REFERENCE TO RELATED PATENT APPLICATIONS

This application claims the benefit of Korean Patent Application No. 10-2009-0072122, filed on Aug. 5, 2009, in the Korean Intellectual Property Office, the entire disclosure of which is incorporated herein by reference.

### BACKGROUND

1. Field of the Invention

A digital photographing apparatus and a moving picture capturing method performed by the same, and more particularly, apparatuses and methods for removing noise created by the digital photographing apparatus from sound of a moving picture.

2. Description of the Related Art

Digital photographing apparatuses, such as digital still cameras (DSCs), digital single-lens reflex (DSLR) cameras, and digital video cameras, often provide the ability to capture moving pictures (movies) with sound. Moving pictures may be referred to as a movie.

Digital photographing apparatuses can be noisy and the noise may be recorded with the sound of the moving picture. The noise may be loud because the microphone is close to where the noise is being created by the digital photographing apparatus. The noise from the digital photographing apparatus may mask the sound that is desired to be recorded with the moving picture. For example, at a birthday party a user of the digital photographing apparatus may capture a moving picture (movie) of the party goers singing happy birthday. But, the user may zoom in during the singing of the happy birthday. The noise that is generated by the zoom operation may be loud compared to the singing of happy birthday because the microphone is close to where the noise is generated and far from where the party goers are singing happy birthday.

Often, in order to address this problem, recording of sound of a moving picture (movie) is stopped when the digital photographing apparatus recording the moving picture (movie) makes noise. However, this is not a complete solution, since a part of the sound of the moving picture (movie) is not recorded. This may be noticeable during the playback of the moving picture. Therefore, there is a need for apparatuses and methods as described herein.

### SUMMARY OF THE INVENTION

Embodiments of the invention provide a digital photographing apparatus and a moving picture (movie) capturing method performed by the same, and more particularly to, a removal of noise of a digital photographing apparatus including sound of a moving picture when the moving picture is being captured.

According to embodiments of the invention, there is provided a method of photographing a moving picture performed by a digital photographing apparatus. The method includes executing a moving picture shooting mode; generating an operation control signal; operating the digital photographing apparatus according to the operation control signal; extracting an offset sound corresponding to the operation control signal; and combining a noise generated by the operation of the digital photographing apparatus and the offset sound.

The operation control signal may be a zooming signal, and the method may include changing an exposure region according to the zooming signal, wherein the digital photographing apparatus performs the changing; extracting an offset sound corresponding to the zooming signal; and combining a noise generated by changing the exposure region and the offset sound.

The operation control signal may be a zooming signal, and the method may include moving a zoom lens of the digital photographing apparatus according to the zooming signal; extracting an offset sound corresponding to the zooming signal; and combining a noise generated by moving the zoom lens and the offset sound.

The operation control signal may be a focusing signal, and the method may include changing a focus of an image input into the digital photographing apparatus according to the focusing signal; extracting an offset sound corresponding to the focusing signal; and combining a noise generated by changing the focus of the image and the offset sound.

The operation control signal may be an auto focus (AF) performing signal, and the method may include performing an AF operation according to the AF performing signal; extracting an offset sound corresponding to the AF performing signal; and combining a noise generated by performing the AF operation and the offset sound.

The noise may be generated by moving a zoom lens or a focus lens.

A waveform of the offset sound may be opposite to that of the noise.

According to embodiments of the invention, there is provided a digital photographing apparatus. The digital photographing apparatus including an operation control signal generating unit, configured to generate an operation control signal; an operation controller, configured to operate the digital photographing apparatus according to the operation control signal generated by the operation control signal generating unit; an offset sound extracting unit, configured to extract an offset sound corresponding to the operation control signal generated by the operation control signal generating unit; and a noise combining unit, configured to combine a noise generated by the operation of the digital photographing apparatus according to the operation controller and the offset sound.

The operation control signal may be a zooming signal, and the digital photographing apparatus may include a zooming signal generating unit, configured to generate the zooming signal; a zooming controller, configured to control a zooming operation of driving a zoom motor according to the zooming signal generated by the zooming signal generating unit and configured to move a zoom lens; an offset sound extracting unit, configured to extract an offset sound corresponding to the zooming signal generated by the zooming signal generating unit; and a noise combining unit, configured to combine a noise generated by controlling the zooming operation of the zooming controller and the offset sound.

The operation control signal may be a focusing signal, and the digital photographing apparatus may include a focusing signal generating unit, configured to generate the focusing signal; a focusing controller, configured to control a focusing operation of driving a zoom motor according to the focusing signal generated by the focusing signal generating unit and configured to move a zoom lens, or to drive a focus motor according to the focusing signal generated by the focusing signal generating unit and configured to move a focus lens; an offset sound extracting unit, configured to extract an offset sound corresponding to the focusing signal generated by the focusing signal generating unit; and a noise combining unit, configured to combine a noise generated by controlling the focusing operation of the focusing controller and the offset sound.

The noise may be generated by moving a zoom lens or a focus lens.

A waveform of the offset sound may be opposite to that of the noise.

The offset sound may be stored in a storage unit.

### BRIEF DESCRIPTION OF THE DRAWINGS

The above and other features and advantages of embodiments of the invention will become more apparent by describing in detail exemplary embodiments thereof with reference to the attached drawings in which:

FIG. 1 is a front and upper perspective view of a digital photographing apparatus according to an embodiment of the invention;

FIG. 2 is a rear view of the digital photographing apparatus of FIG. 1;

FIG. 3 is a block diagram of a digital photographing apparatus according to an embodiment of the invention;

FIG. 4 is a block diagram of a controller of the digital photographing apparatus of FIG. 3 according to an embodiment of the invention;

FIG. 5 is a block diagram of a controller of the digital photographing apparatus of FIG. 3 according to another embodiment of the invention;

FIG. 6 is a block diagram of a controller of the digital photographing apparatus of FIG. 3 according to another embodiment of the invention;

FIGS. 7A through 7C are graphs for describing a method of removing noise of a digital photographing apparatus according to an embodiment of the invention; and

FIGS. 8 and 9 are flowcharts illustrating methods of capturing a moving picture of a digital photographing apparatus according to embodiments of the invention.

### DETAILED DESCRIPTION

Hereinafter, embodiments of the invention will be described in detail with reference to the attached drawings.

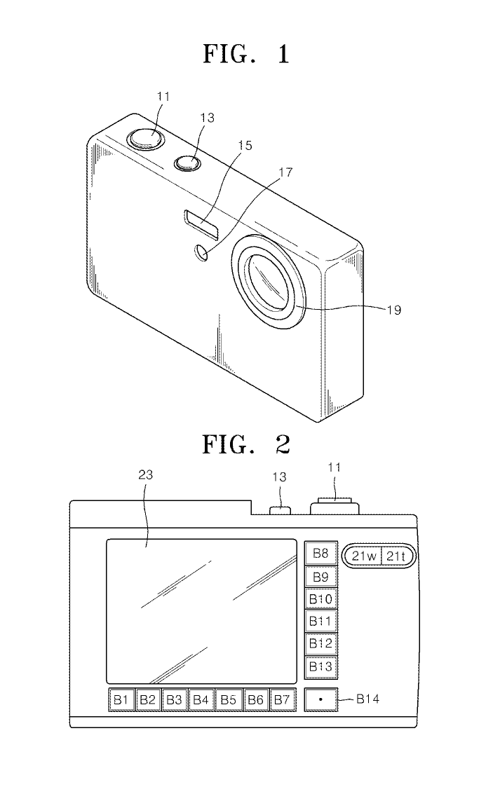

FIG. 1 is a front and upper perspective view of a digital photographing apparatus according to an embodiment of the invention. Referring to FIG. 1, a shutter-release button 11 is pressed and released to expose a charge-coupled device (CCD) to light for a predetermined period of time in a still cut shooting mode or in a moving picture (movie) shooting mode in order to record images via the CCD through appropriate exposure by operating an iris (not shown).

The shutter-release button 11 generates an image or moving picture (movie) photographing signal according to a photographer's input or generates a moving picture photographing stop signal. If the shutter-release button 11 is fully pressed in the moving picture shooting mode, the digital photographing apparatus captures a moving picture (movie) during a period of time for capturing the moving picture (movie). During this time, the digital photographing apparatus continuously captures the moving picture, even if the shutter-release button 11 is released. If the shutter-release button 11 is fully pressed during the capturing of the moving picture, the digital photographing apparatus stops capturing the moving picture.

A power button 13 is pressed to supply power to the digital photographing apparatus in order to operate the digital photographing apparatus.

A flash unit 15 produces an instantaneous flash of light to help illuminate a dark scene. Examples of a flash mode include an auto mode, a fill-in mode, a flash off-mode, a red-eye reduction mode, and a slow synch mode.

An auxiliary light source 17 supplies light onto a subject so that, in dark conditions, the digital photographing apparatus can automatically focus quickly and accurately.

A lens unit 19 optically processes light received from an external light source.

FIG. 2 is a rear view of the digital photographing apparatus of FIG. 1. Referring to FIG. 2, the digital photographing apparatus includes a wide angle-zoom button 21w, a telephoto-zoom button 21t, a display unit 23, and buttons B1 through B14 each including a touch sensor or a contact switch.

The wide angle-zoom button 21w increases the angle of view and the telephoto-zoom button 21t decreases the angle of view, according to manipulation by the photographer. In particular, the wide angle-zoom button 21w and the telephoto-zoom button 21t may be pressed to change the size of a selected exposure area. If the wide angle-zoom button 21w is pressed, the digital photographing apparatus is zoomed out and a subject appears farther away from the digital photographing apparatus. That is, the angle of view increases and thus it is easier to more widely capture the subject and the size of the selected exposure area is decreased. If the telephoto-zoom button 21t is pressed, the digital photographing apparatus is zoomed in and the subject appears closer to the digital photographing apparatus. That is, the angle of view decreases and thus it is easier to more narrowly capture the subject and the selected exposure area is increased.

The buttons B1 through B14 are aligned horizontally and vertically in the vicinity of the display unit 23. For example, if each of the buttons B1 through B14 includes a touch sensor, when one of the horizontal buttons B1 through B7 or one of the vertical buttons B8 through B14 is touched, an item of a main menu, e.g., color or brightness, may be selected or an icon for a sub menu of the main menu may be activated.

Alternatively, if each of the buttons B1 through B14 includes a contact switch, a desired function may be performed by directly selecting an icon of the main menu or an icon of a sub menu. The touch sensors require a smaller amount of force than the contact switches.

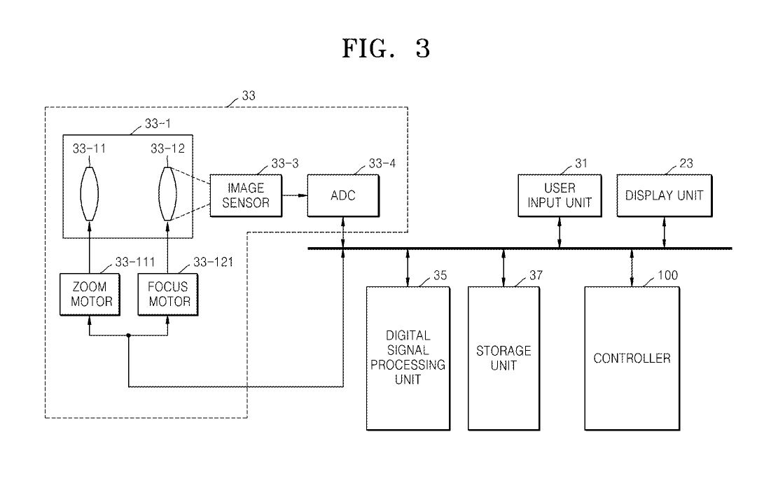

FIG. 3 is a block diagram of a digital photographing apparatus according to an embodiment of the invention. Referring to FIG. 3, the digital photographing apparatus includes the display unit 23, a user input unit 31, an image pickup unit 33, a digital signal processing unit 35, a storage unit 37, and a controller 100.

The user input unit 31 includes the shutter-release button 11, which is pressed and released in order to expose the CCD to light for a given period of time, the power button 13, which is pressed to supply power, the wide angle-zoom button 21w and the telephoto-zoom button 21t, which are respectively pressed to widen and narrow the angle of view, the buttons B1 through B14, which are aligned horizontally and vertically in the vicinity of the display unit 23 to input letters, select a menu, and execute the selected menu, each of the buttons B1 through B14 including a touch sensor or a contact switch, and an auto focus (AF) mode input button (not shown).

The image pickup unit 33 includes a zoom lens 33-11, a zoom motor 33-111 for driving the zoom lens 33-11, a focus lens 33-12, a focus motor 33-121 for driving the focus lens 33-12, an image sensor 33-3, an analog-to-digital converter (ADC) 33-4, a shutter (not shown), and the iris (not shown).

The shutter operates with the iris to adjust the amount of light entering the digital photographing apparatus. The zoom lens 33-11 and the focus lens 33-12 optically process light received from an external light source. At this time, the iris adjusts the amount of incident light according to the size of an opening thereof. The size of the opening of the iris is controlled by the digital signal processing unit 35.

Optical axes of the zoom lens 33-11 and the focus lens 33-12 are identical to a perpendicular line extending from an approximate center of a light receiving surface of the image sensor 33-3. The optical axis of the focus lens 33-12 is movable back and forth in a direction perpendicular to the optical axis. The focus lens 33-12 changes focus of an image formed on the light receiving surface of the image sensor 33-3 according to the position thereof. The focus motor 33-121 adjusts the position of the focus lens 33-12 on its optical axis according to the controller 100.

The optical axis of the zoom lens 33-11 is movable back and forth. The zoom lens 33-11 changes the size of an exposure region of the image formed on the light receiving surface of the image sensor 33-3 according to the position thereof. The zoom motor 33-111 adjusts the position of the zoom lens 33-11 on its optical axis according to the controller 100.

Light through the zoom lens 33-11 and the focus lens 33-12 is accumulated on the image sensor 33-3, and the image sensor 33-3 outputs an image according to the accumulated light, according to a vertical synchronization signal. The digital photographing apparatus captures the image by using the image sensor 33-3, which converts light reflected by a subject into an electrical signal. In order to obtain a color image, the image sensor 33-3 employs a color filter, such as a color filter array (CFA). The CFA is an array of color filters wherein each of a plurality of pixels passes only light having information about a corresponding color, and there are various types of CFA arrangements.

The ADC 33-4 converts an analog image signal output from the image sensor 33-3 into a digital signal.

The digital signal processing unit 35 processes digitized raw data to be displayed. The digital signal processing unit 35 removes a black level caused by a dark current generated in a CCD filter, which is sensitive to a change in temperature. The digital signal processing unit 35 performs gamma correction to encode information, due to human vision having a nonlinear perceptual response to luminance. The digital signal processing unit 35 interpolates a Bayer pattern implemented in RGRG and GBGB lines of (predetermined) gamma corrected data to an RGB line. The digital signal processing unit 35 converts an interpolated RGB signal into a YUV signal, performs edge compensation to filter a Y signal by using a high-pass filter to improve the sharpness of an image, and performs color correction to correct colors of U and V signals by using a standard color coordinate system, and removes noise from the U and V signals. The digital signal processing unit 35 compresses and processes Y, U, and V signals from which noise is removed to generate a joint photographic experts group (JPEG) file, displays the generated JPEG file on the display unit 23, and stores the displayed JPEG file in the storage unit 37.

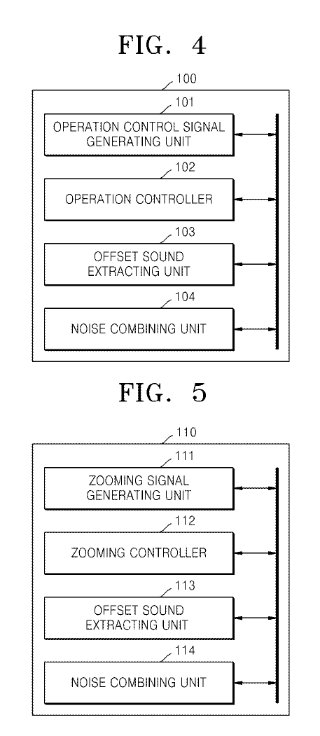

The operation of the controller 100 will be described in more detail with reference to FIGS. 4 through 6.

FIG. 4 is a block diagram of the controller 100 of the digital photographing apparatus of FIG. 3 according to an embodiment of the invention. Referring to FIG. 4, the controller 100 includes an operation control signal generating unit 101, an operation controller 102, an offset sound extracting unit 103, and a noise combining unit 104.

The operation control signal generating unit 101 generates an operation control signal to perform a specific operation in the digital photographing apparatus. The operation control signal generating unit 101 may generate the operation control signal in a shooting mode, a pre-view mode, or a reproduction mode when a still cut image is captured, or when a moving picture is captured. A user may use the user input unit 31 to generate the operation control signal. The operation control signal may instead be automatically generated when the still cut image is captured or when the moving picture is photographed or when an image is processed according to a program or algorithm of the digital photographing apparatus.

The operation controller 102 operates the digital photographing apparatus according to the operation control signal generated by the operation control signal generating unit 101. If the operation control signal generating unit 101 generates the operation control signal to operate the image pickup unit 33, the operation controller 102 may apply an operation performing signal to the zoom motor 33-111 or the focus motor 33-121 to move the zoom lens 33-11 or the focus lens 33-12.

The offset sound extracting unit 103 extracts an offset sound corresponding to the operation control signal generated by the operation control signal generating unit 101. For example, if the digital photographing apparatus performs a zooming operation when a moving picture is being captured, the zoom lens 33-11 and the zoom motor 33-111 may make noises. Such noises depend on types of parts, an operation type of the zoom motor 33-111, and a rotation direction of a barrel, and thus the noises may be determined when the digital photographing apparatus is manufactured.

The offset sound indicates a signal having a particular waveform to offset noise. The waveform of the offset sound may be determined according to the parts and operation of the digital photographing apparatus when the digital photographing apparatus is manufactured and may be stored in the storage unit 37, or may be stored in the storage unit 37 by being generated corresponding to noise generated via an inverse phaser. For example, the offset sound corresponding to the operation control signal generated or information about noise may be stored in the storage unit 37 as shown in a table 1 below.

TABLE 1

| | operation | offset sound | noise |
|---|---|---|---|
| number | control signal | information | information |
| 1 | zooming signal | offset sound a | noise a |
| 2 | focusing signal | offset sound b | noise b |
| . . . | . . . | . . . | . . . |

The noise combining unit 104 combines the noise caused by the operation of the digital photographing apparatus and the offset sound extracted by the offset sound extracting unit 103.

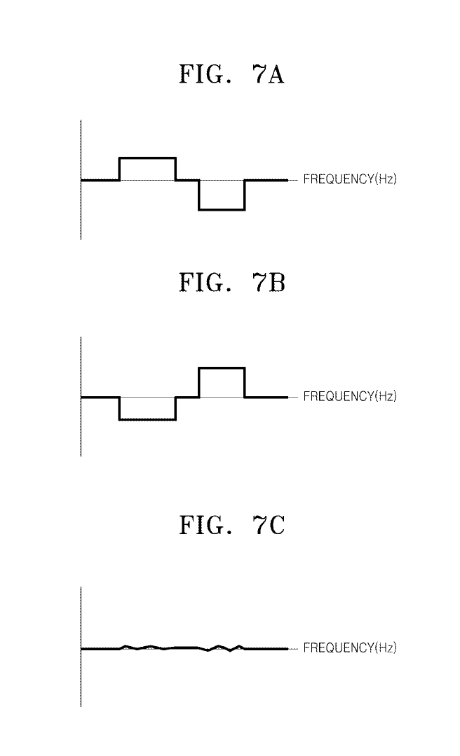

For example, if the noise combining unit 104 combines a noise having a waveform as shown in FIG. 7A and an offset sound having a waveform as shown in FIG. 7B according to cycles of the two waveforms, an amplitude portion (+) of the waveform of the noise is offset with an amplitude portion (−) of the waveform of the offset sound, and an amplitude portion (−) of the waveform of the noise is offset with an amplitude portion (+) of the waveform of the offset sound, thereby removing the noise as shown in FIG. 7C.

FIG. 5 is a block diagram of a controller 110 of the digital photographing apparatus of FIG. 3 according to another embodiment of the invention. The controller 110 of the embodiment is similar to the controller 100 shown in FIG. 3 in that the controller 100 generates an operation control signal, controls an operation, extracts an offset sound corresponding to the operation control signal, and combines the offset sound and a noise generated by the operation. However, the controller 110 of the embodiment is different from the controller 100 shown in FIG. 3 in terms of the type of the operation control signal and the operation according to the operation control signal. Thus, the differences between the controller 110 of the embodiment and the controller 100 shown in FIG. 3 will now be described.

Referring to FIG. 5, the controller 110 may include a zooming signal generating unit 111, a zooming controller 112, an offset sound extracting unit 113, and a noise combining unit 114.

The zooming signal generating unit 111 generates a zooming signal. The zooming signal is a control signal used to perform a zoom-in operation or a zoom-out operation. A user may generate the zooming signal by pressing the wide angle-zoom button 21w or the telephoto-zoom button 21t during a predetermined period of time. The zooming signal may be automatically generated according to a program or algorithm set when a still image or a moving picture is photographed, without using the user input unit 31.

The zooming controller 112 changes an exposure region of the digital photographing apparatus or moves the zoom lens 33-11 according to the zooming signal generated by the zooming signal generating unit 111. For example, the zooming controller 112 controls the zoom motor 33-111 according to the zooming signal to perform a telephoto-zooming operation to move the zoom lens 33-11 along its optical axis so that a subject appears closer to the digital photographing apparatus when the user views the subject through a view finder or the display unit 23 and thus the exposure region of the digital photographing apparatus is changed.

The offset sound extracting unit 113 extracts an offset sound corresponding to the zooming signal. For example, the zoom lens 33-11 and the zoom motor 33-111 inevitably make noises according to the zooming signal for performing the telephoto-zooming operation. The digital photographing apparatus may predict an offset sound with respect to the noises corresponding to the zooming signal and may previously store the offset sound in the storage unit 37. The offset sound extracting unit 113 extracts the offset sound that was previously stored in the storage unit 37 and corresponding to the zooming signal. The operation of the offset sound extracting unit 113 is the same as that of the offset sound extracting unit 103 shown in FIG. 4 and thus the detailed description thereof will not be repeated here.

The noise combining unit 114 combines the noise caused by a zooming operation of the digital photographing apparatus and the offset sound extracted by the offset sound extracting unit 113. For example, the movement of the zoom lens 33-11, the driving of the zoom motor 33-111, and the rotation of a barrel may cause noises corresponding to the zooming operation of the digital photographing apparatus. The noise combining unit 114 combines the noise and the offset sound, thereby removing the noise.

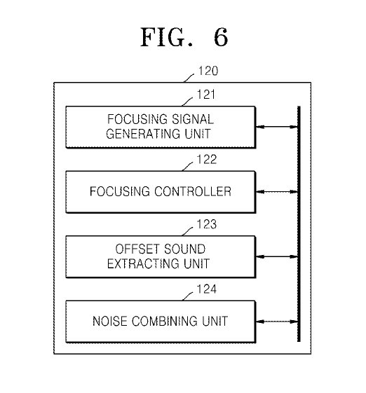

FIG. 6 is a block diagram of the controller 120 of the digital photographing apparatus of FIG. 3 according to another embodiment of the invention. The controller 120 of the embodiment is different from the controller 100 shown in FIG. 3 in terms of the type of the operation control signal and the operation according to the operation control signal. Thus, the differences between the controller 120 of the embodiment and the controller 100 shown in FIG. 3 will now be described.

Referring to FIG. 6, the controller 120 of the embodiment may include a focusing signal generating unit 121, a focusing controller 122, an offset sound extracting unit 123, and a noise combining unit 124.

The focusing signal generating unit 121 generates a focusing signal.

The focusing signal is a control signal used to locate a focus value of a focused subject. The focusing signal may be generated by a user halfway pressing the shutter-release button 11 of the user input unit 31 or by fully pressing the shutter-release button 11 of the user input unit 31 to capture a moving picture (movie). The focusing signal may also be generated by manipulating the user input unit 31 when the moving picture (movie) is being captured or may be automatically generated by automatically detecting the movement of a subject, such as an AF operation.

For example, the focusing signal may be automatically generated in order to locate the subject by detecting sound from the subject and adjusting a focus value of a focused subject. For another example, the focusing signal may be generated by detecting an infrared ray from the subject and locating the subject but the embodiments of the invention are not limited thereto.

The focusing controller 122 operates the digital photographing apparatus according to the focusing signal generated by the focusing signal generating unit 121. The focusing controller 122 changes a focus of an image input to the digital photographing apparatus according to the focusing signal or automatically finds a focus value of a focused image. In more detail, the focusing controller 122 moves the zoom lens 33-11 by driving the zoom motor 33-111 or moves the focus lens 33-12 by driving the focus motor 33-121 according to the focusing signal.

The offset sound extracting unit 123 extracts an offset sound corresponding to the focusing signal. The offset sound may be extracted from the storage unit 37.

The noise combining unit 124 combines the offset sound and a noise caused by the focusing operation of the digital photographing apparatus. For example, the movement of the zoom lens 33-11, the movement of the focus lens 33-12, the driving of the zoom motor 33-111, the driving of the focus motor 33-121, and the rotation of a barrel may cause noises corresponding to the focusing operation of the digital photographing apparatus.

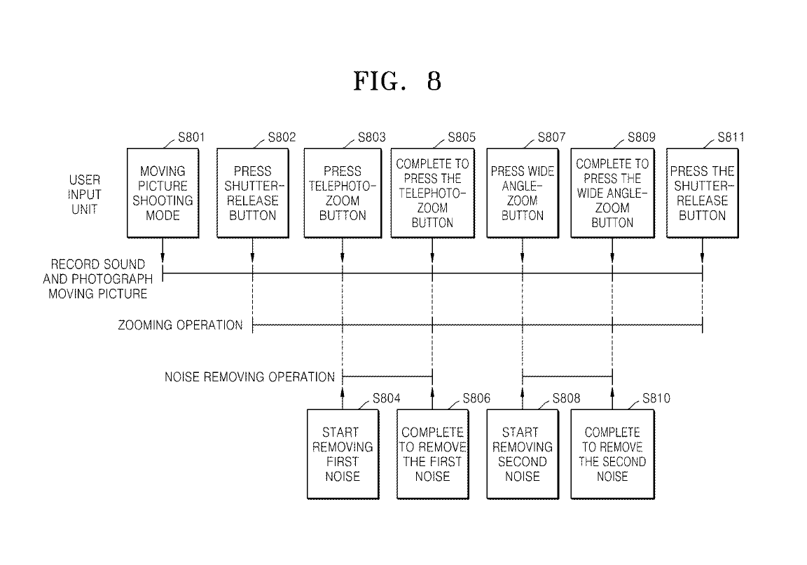

FIG. 8 is a flowchart illustrating a method of capturing a moving picture of a digital photographing apparatus according to an embodiment of the invention.

The method of capturing the moving picture of the digital photographing apparatus according to the embodiment will now be described, in which a zooming operation of the digital photographing apparatus may be performed when the moving picture and sound thereof are simultaneously recorded. A zooming signal may be generated by manipulating the user input unit 31 but the embodiment is not limited thereto. The zooming signal may be automatically generated.

In operation 801, a user executes a moving picture (movie) shooting mode using the user input unit 31. In this operation, a sound removal function is not used and the moving picture shooting mode in which sound is not recorded is entered.

In operation 802, the shutter-release button 11 of the user input unit 31 is pressed to capture a moving picture and record sound of the moving picture.

When the moving picture is being captured, if the telephoto-zoom button 21t of the user input unit 21 is pressed, a telephoto-zooming operation is performed in operation 803. When the telephoto-zoom button 21t of the user input unit 31 is pressed, the digital photographing apparatus zooms in and a subject appears closer to the digital photographing apparatus when the user views the subject through the view finder (not shown) or the display unit 23.

The operation of the image pickup unit 33 of the digital photographing apparatus will now be described in more detail.

In the zoom lens 33-11 disposed in a perpendicular line extending from an optical axis of the image sensor 33-3, the zoom motor 33-111 adjusts a gap between a fixed lens and a moving lens. The zoom lens 33-11 moves to rotate a barrel including the fixed lens and the moving lens clockwise or counterclockwise at a predetermined speed. Such a zooming operation is continuously performed until the user releases the telephoto-zoom button 21t in operation 805. A first noise corresponding to the zooming operation is generated.

The operation of the controller 100 of the digital photographing apparatus that is performed simultaneously with the operation of the image pickup unit 33 will now be described in more detail.

If the user presses the telephoto-zoom button 21t of the user input unit 31, a zooming signal is generated and a first offset sound corresponding to the zooming signal is extracted. The first noise caused by the zooming operation is due to the movement of the zoom lens 33-11 and the driving of the zoom motor 33-111, and the first noise and the first offset sound are combined. The first offset sound indicated by an inverse phase of the waveform of the noise shown in FIG. 7A is combined with the first noise in accordance with a cycle of the first noise and thus the first noise is removed.

The noise removal operation is continuously performed until the zooming signal is no longer input in operation 807, i.e., until the user releases the telephoto-zoom button 21t (operation 806).

In more detail, if a telephoto-zoom signal is input for two seconds by pressing the telephoto-zoom button 21t for two seconds in order to set an optical 3× zoom ratio, the digital photographing apparatus starts combining sound of a moving picture and an offset sound when the telephoto-zoom signal is input during the capturing of the moving picture including the sound and stops combining the sound and the offset sound when the telephoto-zoom signal is no longer input. Then if a moving picture file of the moving picture) is reproduced, a noise caused by performing the telephoto-zoom operation is offset and removed.

If the user presses the wide-angle zoom button 21w when the moving picture is being captured, a wide angle zooming operation is performed in operation 80). When the wide-angle zoom button 21w of the user input unit 31 is pressed, the digital photographing apparatus zooms out and the subject appears farther away from the digital photographing apparatus.

The operation of the image pickup unit 33 of the digital photographing apparatus that is performed simultaneously with the operation of the controller 100 will now be described in more detail.

In the zoom lens 33-11 disposed in a perpendicular line extending from an optical axis of the image sensor 33-3, the zoom motor 33-111 adjusts the gap between the fixed lens and the moving lens. Such a zooming operation is continuously performed until the user releases the wide-angle zoom button 21w in operation 809. A second noise corresponding to the zooming operation is generated until operation 809 is completely performed.

The operation of the controller 100 of the digital photographing apparatus that is performed simultaneously with the operation of the image pickup unit 33 will now be described in more detail.

If the user presses the wide-angle zoom button 21w of the user input unit 31, a zooming signal is generated, and the controller 100 detects the zooming signal and extracts a second offset sound corresponding to the zooming signal. The second noise caused by the zooming operation performed by pressing the wide-angle zoom button 21w and the second offset sound are combined and thus the second noise is removed.

The noise removal operation is continuously performed in operation 810 until the zooming signal is no longer input, i.e., until the user releases the wide-angle zoom button 21w (operation 809).

In operation 8111, capturing of the moving picture is complete by pressing the shutter-release button 11. The user can obtain the moving picture file including sound from which a zoom noise is removed.

As described above, a zooming operation makes various types of mechanical noise, such as a noise generated by a zoom motor, a noise generated by rotating a lead screw in the zoom motor, a noise generated by rotating the barrel including the fixed lens and moving lens, and the like. Such noises are generated by operating the digital photographing apparatus irrespective of time and place. A microphone included in the digital photographing apparatus may be used to record sound. Since the microphone is close to an image pickup unit, the noise recorded is louder than sound recorded.

However, embodiments of the invention removes a noise in real time by using an offset sound, thereby preventing a mechanical noise from being recorded even if a zooming function is used while capturing a moving picture. Since it is unnecessary to detect the noise, the noise is removed in real time. In more detail, a unit for removing a noise generated by a zooming operation control signal makes it possible to remove the noise by using a simple circuit and algorithm and an offset sound stored in memory.

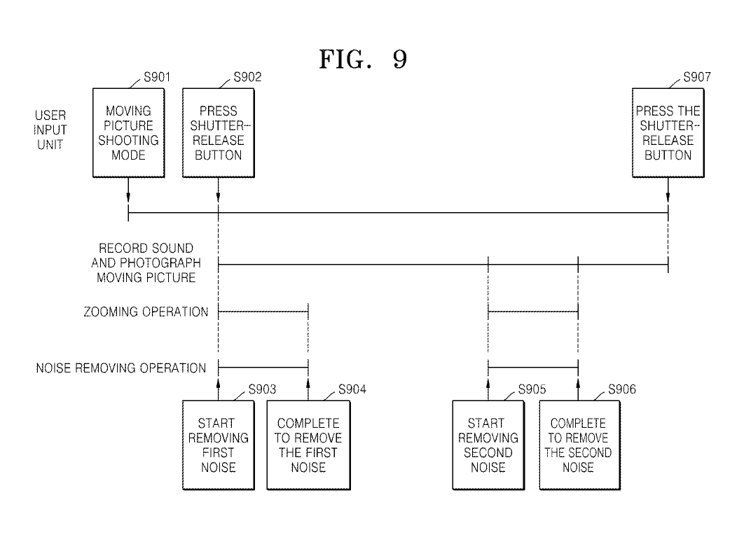

FIG. 9 is a flowchart illustrating a method of capturing a moving picture of a digital photographing apparatus according to another embodiment of the invention.

The method of capturing the moving picture of the digital photographing apparatus of the embodiment is different from the method of capturing the moving picture of the digital photographing apparatus described with reference to FIG. 8 in that an operation control signal is a focusing signal. The method of capturing the moving picture of the digital photographing apparatus of the embodiment will now be described when an AF operation is performed while simultaneously recording the moving picture (movie) and sound thereof.

In operation 901, a user executes a moving picture shooting mode through the user input unit 31. In this regard, a sound removal function is not used and the moving picture shooting mode in which sound is not recorded is entered.

In operation 902, the moving picture and sound thereof are recorded by fully pressing the shutter-release button 11 of the user input unit 31. At the same time, the focusing signal is generated by halfway pressing the shutter-release button 11 of the user input unit 31.

If a controller drives a zoom motor and a focus motor to control the positions of a zoom lens and a focus lens according to the focusing signal, an image pickup unit focuses on a desired subject.

If the focusing signal is generated, in operation 903, the controller extracts a first offset sound corresponding to the focusing signal, combines the first offset sound and a first noise corresponding to a focusing operation, and removes mechanical noise generated by focusing on the subject. In operation 904, operation 903 is continuously performed until the subject is in focus.

In operation 905, the focusing signal is generated in order to find a focus value of the focused subject when the moving picture is being captured. For example, a desired subject is automatically focused on by pressing the shutter-release button 11 halfway in a manual focus mode, so that a user can focus on a subject that repeatedly moves by pressing the shutter-release button 11 halfway. The focusing signal is generated when the shutter-release button 11 is pressed halfway.

For another example, the focusing signal may be generated by automatically detecting movement of a subject in an AF mode. The focusing signal may be generated by detecting sound from the subject or an infrared ray from the subject and locating the subject. However, the method of performing the AF operation is not limited thereto and different methods can be used according to a program of the digital photographing apparatus.

If the focusing signal is generated, the image pickup unit operates to find the focus value of the subject. At the same time, the controller extracts a second offset sound according to the focusing signal and combines the second offset sound and a second noise until the focusing operation is completely performed in operation 906.

In operation 907, the capturing of the moving picture is completed by pressing the shutter-release button 11 all the way and thus a moving picture file from which operation noise is removed can be obtained.

A mechanical sound of the digital photographing apparatus is previously stored in a memory and is used during capturing of a moving picture, thereby removing a noise in real time.

According to another embodiment, the method of capturing the moving picture of the digital photographing apparatus of the embodiment will now be described when an optical image stabilization (OIS) operation is performed simultaneously recording the moving picture and sound thereof.

The embodiment is different from the two previous embodiments described with reference to FIGS. 8 and 9 in that the OIS operation and a noise removal operation are not performed according to an operation control signal generated by operating a user input unit.

If a handshake detecting sensor detects a handshake during the photographing of the moving picture, an OIS unit estimates and calculates movement of the moving picture according to an algorithm and operates an OIS device to offset the handshake.

In this regard, the OIS device may make a noise. If the handshake detecting sensor detects the handshake and the operation control signal used to control the OIS unit is generated, an offset sound corresponding to the operation control signal is extracted, the offset sound is combined with the noise of the OIS device, and the noise is removed. Such operations are performed whenever the OIS operation is performed until capturing of the moving picture is complete by pressing the shutter-release button 11 all the way.

The various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of instructions on a machine readable medium and/or computer readable medium.

As described above, according to embodiments of the invention, when a moving picture including sound is being captured, it is possible to prevent a mechanical noise generated by a digital photographing apparatus from being recorded in real time, and to seamlessly record the sound.

While embodiments of this invention has been particularly shown and described with reference to embodiments thereof, it will be understood by those of ordinary skill in the art that various changes in form and details may be made therein without departing from the spirit and scope of the invention as defined by the appended claims. The embodiments should be considered in descriptive sense only and not for purposes of limitation. Therefore, the scope of the invention is defined not by the detailed description of the invention but by the appended claims, and all differences within the scope will be construed as being included in embodiments of the invention.

What is claimed is:

1. A method of photographing a moving picture performed by a digital photographing apparatus, the method comprising:
executing a moving picture shooting mode;
generating an operation control signal;
operating the digital photographing apparatus according to the operation control signal;
extracting an offset sound corresponding to the operation control signal; and
combining a noise generated by the operation of the digital photographing apparatus and the offset sound.

2. The method of claim 1, wherein the operation control signal is a zooming signal, further comprising:
changing an exposure region according to the zooming signal, wherein the digital photographing apparatus performs the changing;
extracting an offset sound corresponding to the zooming signal; and
combining a noise generated by changing the exposure region and the offset sound.

3. The method of claim 1, wherein the operation control signal is a zooming signal, further comprising:
moving a zoom lens of the digital photographing apparatus according to the zooming signal;
extracting an offset sound corresponding to the zooming signal; and
combining a noise generated by moving the zoom lens and the offset sound.

4. The method of claim 1, wherein the operation control signal is a focusing signal, further comprising:
changing a focus of an image input into the digital photographing apparatus according to the focusing signal;
extracting an offset sound corresponding to the focusing signal; and
combining a noise generated by changing the focus of the image and the offset sound.

5. The method of claim 1, wherein the operation control signal is an auto focus (AF) performing signal, further comprising:
performing an AF operation according to the AF performing signal;
extracting an offset sound corresponding to the AF performing signal; and
combining a noise generated by performing the AF operation and the offset sound.

6. The method of claim 1, wherein the noise is generated by moving a zoom lens or a focus lens.

7. The method of claim 1, wherein a waveform of the offset sound is opposite to that of the noise.

8. A digital photographing apparatus comprising:
an operation control signal generating unit, configured to generate an operation control signal;
an operation controller, configured to operate the digital photographing apparatus according to the operation control signal generated by the operation control signal generating unit;
an offset sound extracting unit, configured to extract an offset sound corresponding to the operation control signal generated by the operation control signal generating unit; and
a noise combining unit, configured to combine a noise generated by the operation of the digital photographing apparatus according to the operation controller and the offset sound.

9. The digital photographing apparatus of claim 8, wherein the operation control signal is a zooming signal, further comprising:
a zooming signal generating unit, configured to generate the zooming signal;
a zooming controller, configured to control a zooming operation of driving a zoom motor according to the zooming signal generated by the zooming signal generating unit and configured to move a zoom lens;
an offset sound extracting unit, configured to extract an offset sound corresponding to the zooming signal generated by the zooming signal generating unit; and
a noise combining unit, configured to combine a noise generated by controlling the zooming operation of the zooming controller and the offset sound.

10. The digital photographing apparatus of claim 8, wherein the operation control signal is a focusing signal, further comprising:
a focusing signal generating unit, configured to generate the focusing signal;
a focusing controller, configured to control a focusing operation of driving a zoom motor according to the focusing signal generated by the focusing signal generating unit and configured to move a zoom lens, or to drive a focus motor according to the focusing signal generated by the focusing signal generating unit and configured to move a focus lens;
an offset sound extracting unit, configured to extract an offset sound corresponding to the focusing signal generated by the focusing signal generating unit; and
a noise combining unit, configured to combine a noise generated by controlling the focusing operation of the focusing controller and the offset sound.

11. The digital photographing apparatus of claim 8, wherein the noise is generated by moving a zoom lens or a focus lens.

12. The digital photographing apparatus of claim 8, wherein a waveform of the offset sound is opposite to that of the noise.

13. The digital photographing apparatus of claim 8, wherein the offset sound is stored in a storage unit.
